(19) United States
(12) Patent Application Publication
(10) Pub. No.: US 2012/0299632 A1
(43) Pub. Date: Nov. 29, 2012

(54) SIMULTANEOUS SIGNAL INPUT MATCHING AND LINEARIZATION

(75) Inventors: Mihai A. T. Sanduleanu, Yorktown Heights, NY (US); Alberto Valdes Garcia, Hartsdale, NY (US)

(73) Assignee: International Business Machines Corporation, Armonk, NY (US)

(21) Appl. No.: 13/278,367

(22) Filed: Oct. 21, 2011

Related U.S. Application Data
(60) Provisional application No. 61/489,146, filed on May 23, 2011.

(51) Int. Cl. G06G 7/12

(52) U.S. Cl. 327/355

(57) ABSTRACT

An amplifier, mixer, and method for input impedance matching and linearization. The transconductor includes a first differential transistor and a second differential transistor, including a first differential source and a second differential source electrically connected at a source node. The transconductor includes a pair of transmission lines including a first line of the pair of transmission lines electrically connected to the first of the two differential voltage inputs and a second line of the pair of transmission lines electrically connected to the second of the two differential voltage inputs. The pair of transmission lines is electrically connecting the two differential voltage inputs at a common node. The transconductor also includes a linearization unit including one or more linearization transistors. The one or more linearization transistors include a linearization gate electrically connected to the common node. The linearization unit is configured to supply a virtual ground at the source node.

### CROSS-REFERENCE TO RELATED APPLICATIONS

This application claims priority under 35 U.S.C. §120 to U.S. Provisional Patent Application No. 61/489,146 filed May 23, 2011, the entire text of which is specifically incorporated by reference herein.

### STATEMENT REGARDING FEDERALLY SPONSORED RESEARCH

This invention was made with Government support under Contract No.: FA8650-09-C-7924 (Defense Advanced Research Projects Agency (DARPA)). The Government has certain rights in this invention.

### BACKGROUND

The present invention is directed towards signal reception/transmission/detection devices, and more particularly to the linearization and input impedance matching of received/transmitted signals.

When the physical dimensions of an electrical system are comparable to the size of the electromagnetic waves being carried on the system, reflections may occur when the impedances in the system do not match. Additionally, electronic devices usually have an associated linearity. Linearity is a measure of how well the output of a device represents the input. A device may have a linear operating range in which the output is linear and a non-linear range in which the output is non-linear. For example, a device receiving a sinusoidal wave as input may output a sinusoidal wave if the wave amplitude is within the linear operating range of the device. If the sinusoidal input wave has a large amplitude outside the linear operating range, however, the input wave might be clipped, producing a distorted output such as a square wave. The distortion of the received signal results in loss of the information carried by it.

### BRIEF SUMMARY

An example embodiment of the present invention is a transconductor configured for input impedance matching and linearization. The transconductor includes a differential transistor pair having a first differential transistor and a second differential transistor. The first differential transistor includes a first differential gate, a first differential source, and a first differential drain. The first differential gate is electrically connected to a first of two differential voltage inputs. The second differential transistor includes a second differential gate, a second differential source, and a second differential drain. The second differential gate is electrically connected to a second of the two differential voltage inputs. The first differential source and the second differential source are electrically connected at a source node.

The transconductor also includes a pair of transmission lines. A first line of the pair of transmission lines is electrically connected to the first of the two differential voltage inputs and a second line of the pair of transmission lines is electrically connected to the second of the two differential voltage inputs. The pair of transmission lines is electrically connecting the two differential voltage inputs at a common node. The transconductor also includes a linearization unit including one or more linearization transistors. The one or more linearization transistors includes a linearization gate. The linearization gate is electrically connected to the common node, and the linearization unit is configured to supply a virtual ground at the source node.

Another example embodiment of the present invention is a mixer configured for input impedance matching and linearization. The mixer includes a differential transistor pair having a first differential transistor and a second differential transistor. The first differential transistor includes a first differential gate, a first differential source, and a first differential drain. The first differential gate is electrically connected to a first of two differential voltage inputs. The second differential transistor includes a second differential gate, a second differential source, and a second differential drain. The second differential gate is electrically connected to a second of the two differential voltage inputs. The first differential source and the second differential source are electrically connected at a source node.

The mixer also includes a pair of transmission lines. A first line of the pair of transmission lines is electrically connected to the first of the two differential voltage inputs and a second line of the pair of transmission lines is electrically connected to the second of the two differential voltage inputs. The pair of transmission lines is electrically connecting the two differential voltage inputs at a common node. The mixer includes a linearization unit including one or more linearization transistors. The one or more linearization transistors include a linearization gate. The linearization gate is electrically connected to the common node, and the linearization unit is configured to supply a virtual ground at the source node. The mixer also includes a mixing unit including a mixing transistor. The mixing transistor includes a mixing source, a mixing gate, and a mixing drain. The mixing gate is electrically connected to a local oscillator, and the mixing source is electrically connected to the source node.

Yet another example embodiment of the invention is a method for input impedance matching and linearization. The method includes providing a first differential transistor. The first differential transistor is part of a differential transistor pair having a first differential transistor and a second differential transistor. The first differential transistor includes a first differential gate, a first differential source, and a first differential drain. The first differential gate is electrically connected to a first of two differential voltage inputs. The method includes providing a second differential transistor. The second differential transistor includes a second differential gate, a second differential source, and a second differential drain. The second differential gate is electrically connected to a second of the two differential voltage inputs. The first differential source and the second differential source are electrically connected at a source node.

The method includes providing a pair of transmission lines. The pair of transmission lines includes a first line of the pair of transmission lines electrically connected to the first of the two differential voltage inputs and a second line of the pair of transmission lines electrically connected to the second of the two differential voltage inputs. The pair of transmission lines is electrically connecting the two differential voltage inputs at a common node. The method also includes providing a linearization unit including one or more linearization transistors. The one or more linearization transistors include a linearization gate. The linearization gate is electrically connected to the common node, and the linearization unit is configured to supply a virtual ground at the source node.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example RF transconductor contemplated by the present invention.

FIG. 2 shows an example RF amplifier contemplated by the present invention.

FIG. 3 shows an example single-balanced mixer contemplated by the present invention.

FIG. 4 is a schematic view showing an example embodiment of another transconductor configured for input impedance matching and linearization.

FIG. 5 shows a schematic view of an example embodiment of a mixer configured for input impedance matching and linearization.

FIG. 6 shows a flow chart of an example embodiment of a method for input impedance matching and linearization.

### DETAILED DESCRIPTION

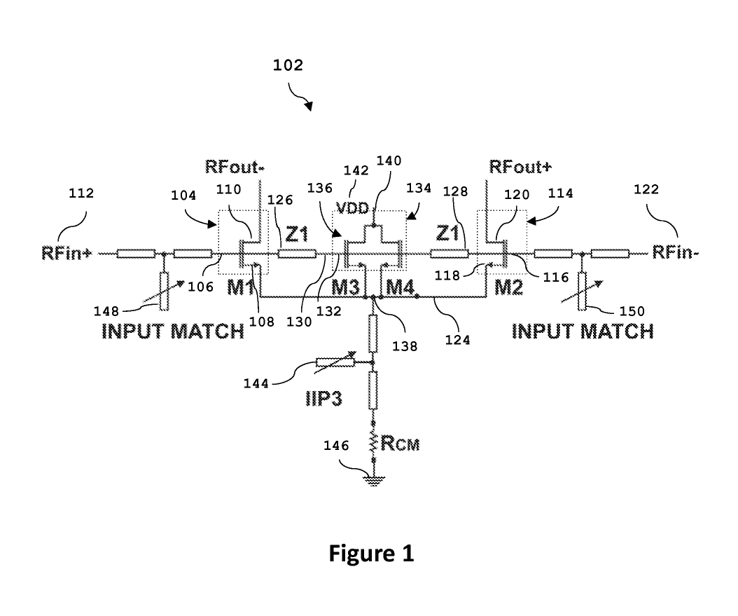

The present invention is described with reference to embodiments of the invention. Throughout the description of the invention reference is made to FIGS. 1-3. As discussed in detail below, embodiments of the present invention include a transconductor, mixer, an amplifier and method for input impedance matching and linearization. Some embodiments of the transconductor, mixer, amplifier and method below may be configured for millimeter wave applications, but other embodiments may be directed to other kinds of applications.

FIG. 1 shows an example RF transconductor 102 contemplated by the present invention. The RF linearized transconductor stage is based on M1, M2, M3 and M4. Furthermore, there is tunable transmission line for S11 and IIP3 healing. The Z1 impedance can be implemented as, for example, a transmission line in series with a small resistor.

The transconductor 102 may include a differential transistor pair having a first differential transistor 104 and a second differential transistor 114. In one embodiment, the first differential transistor 104 includes a first differential gate 106, a first differential source 108, and a first differential drain 110. The first differential gate 106 may be electrically connected to a first 112 of two differential voltage inputs.

In one embodiment, the second differential transistor 114 includes a second differential gate 116, a second differential source 118, and a second differential drain 120. The second differential gate 116 may be electrically connected to a second 122 of the two differential voltage inputs. The first differential source 108 and the second differential source 118 may be electrically connected at a source node 124. The first differential transistor 104 and second differential transistor 114 may be CMOS transistors. Additionally, the first differential transistor 104 may be configured to convert a voltage signal received at the first differential gate 106 into a first differential current at the first differential drain 110, and the second differential transistor 114 may be configured to convert a voltage signal received at the second differential gate 116 into a second differential current at the second differential drain 120.

In one embodiment, the transconductor includes a pair of transmission lines, including a first line 126 and a second line 128. The first line 126 and the second line 128 of the pair of transmission lines may each have complex impedances for input matching and linearization. The first line 126 of the pair of transmission lines may be electrically connected to the first 112 of the two differential voltage inputs, and the second line 128 of the pair of transmission lines may be electrically connected to the second 122 of the two differential voltage inputs. The pair of transmission lines 126 and 128 may be electrically connecting the two differential voltage inputs 112 and 122 at a common node 130. The first line 126 of the pair of transmission lines may be electrically connected between the first differential gate 106 and the linearization gate 132 described below, and the second line 128 of the pair of transmission lines may be electrically connected between the second differential gate 116 and the linearization gate 132.

The first line 126 of the pair of transmission lines and the second line 128 of the pair of transmission lines may both have large impedances and be configured to act in parallel to the input capacitances of the first differential transistor 104 and second differential transistor 114. In one embodiment, the pair of transmission lines 126 and 128 is configured to match an input capacitance of the first differential transistor 104 and an input capacitance of the second differential transistor 114. This may be accomplished, for example, by configuring the pair of transmission lines 126 and 128 to provide a differential inductance to match the differential capacitance of the first differential transistor 104 and second differential transistor 114. Both input matching and linearization of the transconductor 102 may depend, at least in part, on the pair of transmission lines 126 and 128. Thus, input matching and linearization may be achieved simultaneously.

The transconductor 102 may include a linearization unit 134. The linearization unit 134 may include one or more linearization transistors 136. In one embodiment, the one or more linearization transistors 136 includes a linearization gate 132. The one or more linearization transistors 136 may include a linearization source 138. The one or more linearization transistor 136 may also include a linearization drain 140 electrically connected to a linearization voltage supply 142. The linearization gate 132 may be electrically connected to the common node 130. The one or more linearization transistors 136 may be a composite transistor, including more than one transistor, with all transistors having collectively a common linearization source 138, common linearization gate 132, and common linearization drain 140. The linearization unit 134 may be configured to supply a virtual ground at the source node 124. This may be accomplished at least in part by connecting the linearization source 138 to the source node 124. A virtual ground is a node with a potential that does not substantially change with variation in differential voltage inputs 112 and 122.

The one or more linearization transistors 136 of the linearization unit 134 may be configured to absorb signal fluctuations in the source node 124. The ability of the linearization unit 134 to absorb signal fluctuations may depend, at least in part, upon the complex impedances of the pair of transmission lines 126 and 128 described above. In one embodiment, the linearization unit 134 is configured to linearize the first differential transistor 104 and second differential transistor 114 without significantly reducing their respective transistor gain. The linearization unit may be centered between the two differential voltage inputs.

In one embodiment, the linearization transistor 136 is twice the size of the first differential transistor 104 or the second differential transistor 114. In the case of a composite linearization transistor, the one or more linearization transistors 136 may include two transistors, each the size of the first differential transistor 104 or second differential transistor 114. Although FIG. 1 shows a composite linearization transistor 136, it is noted that two transistors as a composite transistor 136 can also be represented with only one transistor. Thus, the circuit symbols depicting the one or more linearization transistors 136 may correspond to a single transistor or more than one transistor combined as a composite transistor.

In one embodiment, the transconductor 102 includes a source node transmission line 144 electrically connected between the source node 124 and a circuit ground 146. The source node transmission line 144 may have an adjustable impedance. In one embodiment, the source node transmission line 144 with the adjustable impedance is used to tune the input intercept point for the third harmonic (“IIP3”), which may be used a measurement of linearity. The source node transmission line 144 with the adjustable impedance may also be configured such that the intercept point for the second harmonic (“IIP2”) may additionally be improved.

The source node transmission line 144 may, for example, include a digitally controlled, independent modification of both the capacitance and the inductance of the structure. This allows for covering of the entire functional space for such a device. For example, the source node transmission line 144 may allow for the modification of the effective electrical length while keeping the impedance constant, as well as the modification of the capacitance only while keeping the inductance constant, as well as the modification of the inductance while keeping the capacitance constant, etc.

The capacitance is modified by connecting C port lines, which are close and orthogonal to the signal wire of the transmission line, either to ground or to a floating potential. The orthogonal C port lines are grouped together, thereby enabling modeling of variable length transmission lines.

The inductance is modified by switching the return current of the transmission line between several side shielding wires. This changes the loop area and the resulting inductance per unit length. The change of capacitance in this case is negligible.

The transconductor 102 may be incorporated into a mixer, amplifier, or other circuit. The transconductor 102 may be configured to receive a signal in the millimeter wave range from the two differential voltage inputs 112 and 122. For example, the transconductor 102 may be integrated into a millimeter wave detection device. Embodiments of the transconductor 102, however, are not limited to applications in the millimeter wave range.

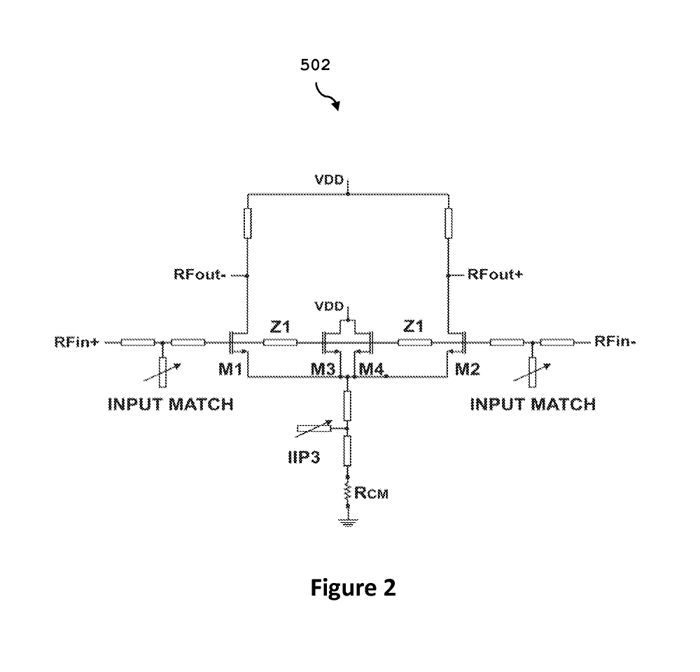

FIG. 2 shows an example RF amplifier 502 contemplated by the present invention. By adding a resonant load, such as a T-line or inductor, a linearized amplifier can be implemented.

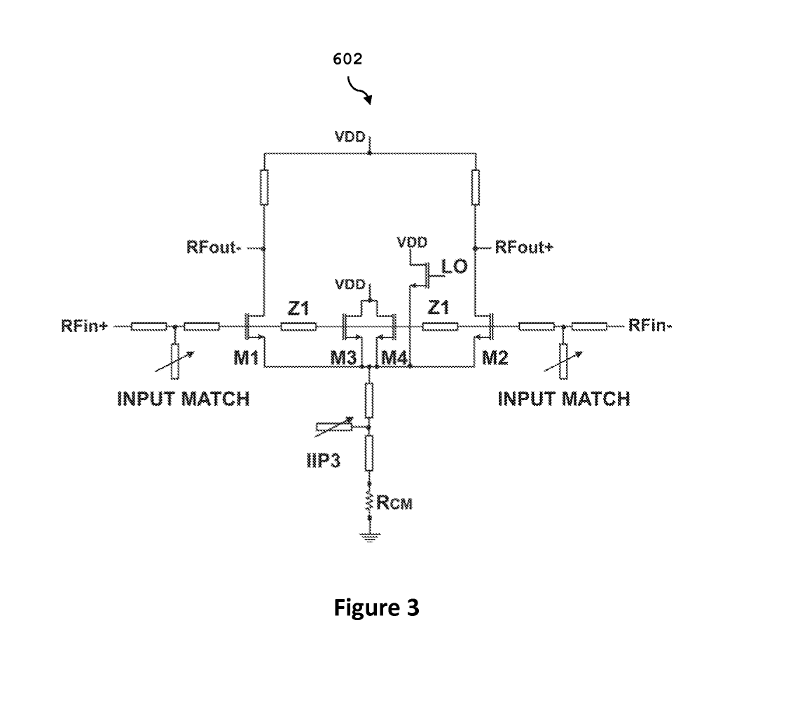

FIG. 3 shows an example single-balanced mixer 602 contemplated by the present invention. By adding a LO transistor, as shown, a mixer with an IF>0 Hz is implemented. The LO transistor turns on and off the linearized pair, thus providing more voltage room.

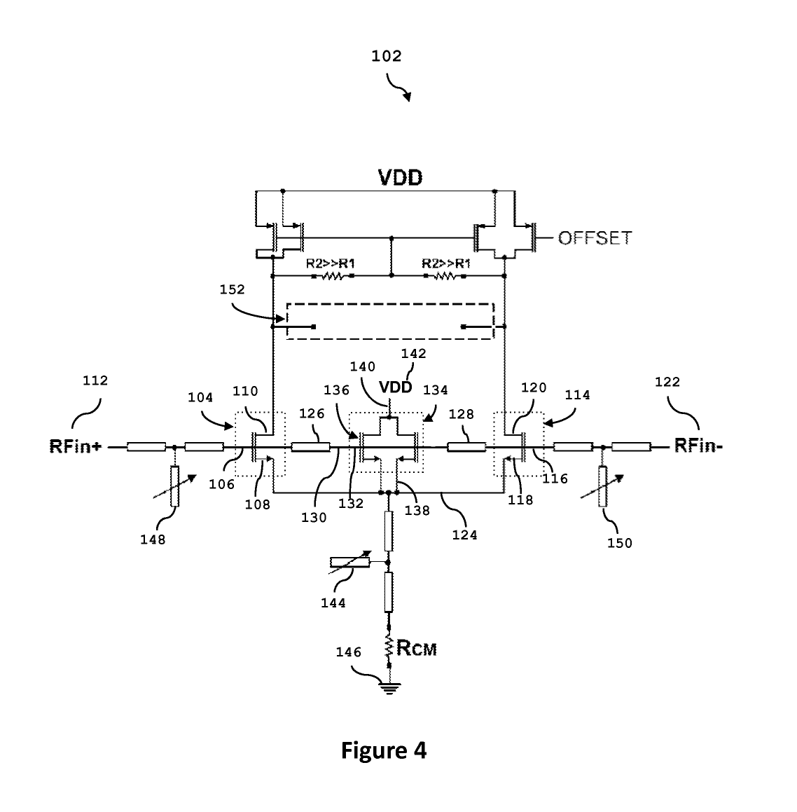

FIG. 4 is a schematic view showing another example embodiment of a transconductor 102 configured for input impedance matching and linearization. As mentioned above, the transconductor 102 may include a differential transistor pair having a first differential transistor 104 and a second differential transistor 114. In one embodiment, the transconductor 102 includes a first input matching transmission line 148 electrically connected between the first 112 of the two differential voltage inputs and the first differential transistor 104. The transconductor 102 may also include a second input matching transmission line 150 electrically connected between the second 122 of the two differential voltage inputs and the second differential transistor 114. In one embodiment, at least one of the first input matching transmission line 148 and the second input matching transmission line 150 has an adjustable impedance, as detailed above. The first input matching transmission line 148 and second input matching transmission line 150 may be adjusted independently and may be used for improving the 180 degrees phase relationship between the two differential voltage inputs 112 and 122. The first input matching transmission line 148, second input matching transmission line 150, and source node transmission line 144 may each include one or more transmission lines.

The first input matching transmission line 148, the second input transmission line 150, and the pair of transmission lines 126 and 128 may be part of an input matching network. The first input matching transmission line 148 may be configured to match the impedance from the first 112 of two differential voltage inputs to the impedance of the first differential transistor 104, and the second input matching transmission line 150 may be configured to match the impedance from a second 122 of two differential voltage inputs to the second differential transistor 114. The pair of transmission lines 126 and 128 may be configured to assist the first input matching transmission line 148 and second input matching transmission line 150 to match the impedances of the two differential voltage inputs 112 and 122.

In one embodiment, the transconductor 102 is a transconductor that includes a differential output current 152 between the first differential drain 110 of the first differential transistor 104 and the second differential drain 120 of the second differential transistor 114. The transconductor 102 may also include additional circuitry to convert the current back into a voltage as well as perform other operations contemplated by those of ordinary skill in the art.

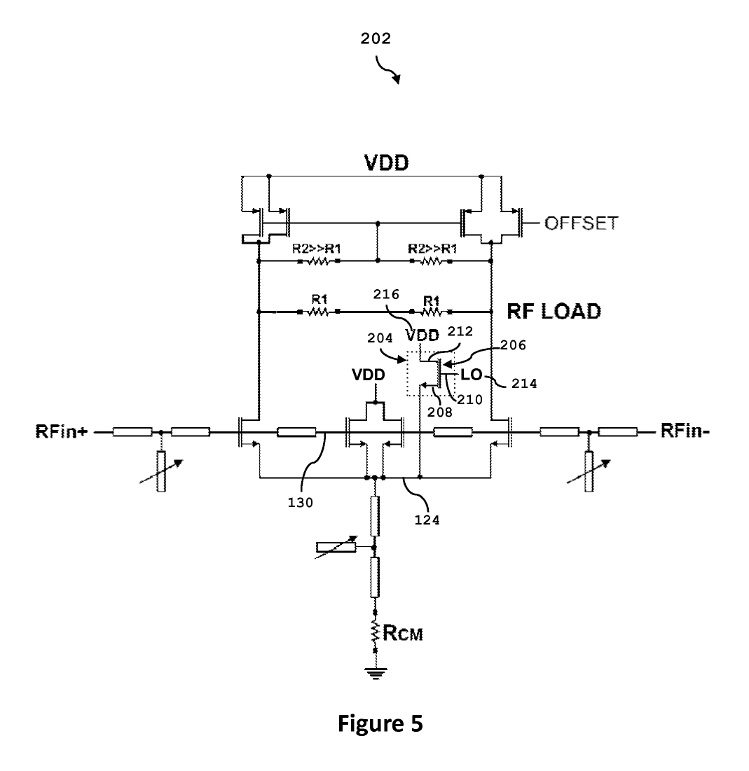

FIG. 5 shows a schematic view of an example embodiment of a mixer 202 configured for input impedance matching and linearization. The mixer 202 may include some or all the features of the transconductor 102 described above. In addition to the features of transconductor 102, the mixer 202 may also include a mixing unit 204. The mixing unit 204 may include a mixing transistor 206. In one embodiment, the mixing transistor 206 includes a mixing source 208, a mixing gate 210, and a mixing drain 212. The mixing gate 210 may be electrically connected to a local oscillator 214.

In one embodiment, the local oscillator 214 provides a signal at a different frequency than the signal from the two differential voltage inputs 112 and 122. For example, the local oscillator 214 may provide a signal with a frequency that is different from the input signal by a few GHz. The mixing source 208 may be electrically connected to the source node 124. The mixing drain 212 may be electrically connected to a mixer voltage supply 216.

In one embodiment, the mixer 202 is configured to convert a high frequency input to a lower frequency. An example of a high frequency may include a 60 GHz input signal, but the mixer 202 may be configured for other frequencies in the millimeter wave range or other wave ranges. The selection of the different frequency received from the local oscillator 214 may depend on the application of the mixer 202. In one embodiment, the local oscillator 214 is configured to pull the signal on the common node 130 up and down at the different frequency such that the gate to source voltage ratio of the first differential transistor 104 and the second differential transistor 114 becomes small, effectively turning the first differential transistor 104 and second differential transistor 114 on and off.

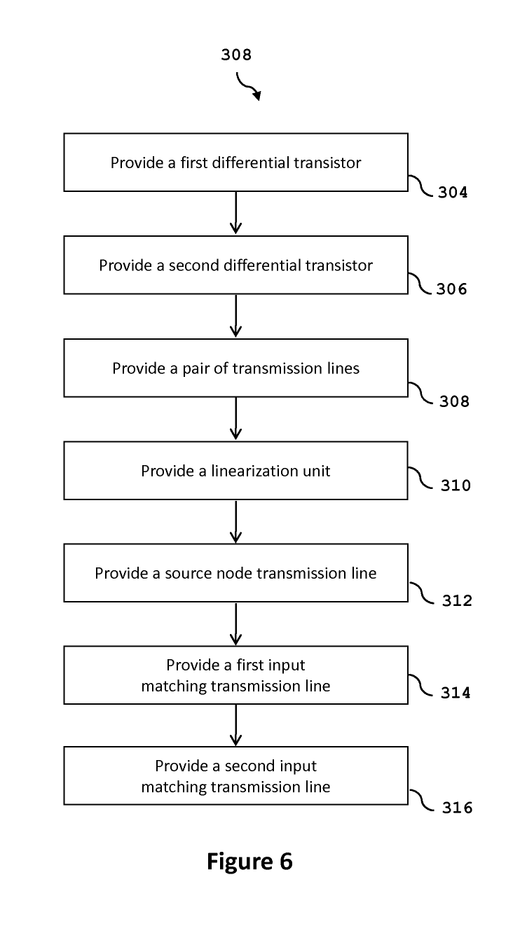

FIG. 6 shows a flow chart of an example embodiment of a method 302 for input impedance matching and linearization. In one embodiment, the method 302 includes a first differential transistor providing step 304 of providing a first differential transistor. The first differential transistor may be part of a differential transistor pair having a first differential transistor and a second differential transistor. The first differential transistor may include a first differential gate, a first differential source, and a first differential drain. In one embodiment, the first differential gate is electrically connected to a first of two differential voltage inputs.

The method 302 may include a second differential transistor providing step 306 of providing a second differential transistor. In one embodiment, the second differential transistor includes a second differential gate, a second differential source, and a second differential drain. The second differential gate may be electrically connected to a second of the two differential voltage inputs. The first differential source and the second differential source may be electrically connected at a source node. The first differential transistor and second differential transistor as well as their elements are described in further detail above.

In one embodiment, the method 302 includes a pair of transmission lines providing step 308 of providing a pair of transmission lines. A first line of the pair of transmission lines may be electrically connected to the first of the two differential voltage inputs, and a second line of the pair of transmission lines may be electrically connected to the second of the two differential voltage inputs. The pair of transmission lines may be electrically connecting the two differential voltage inputs at a common node. In one embodiment, the pair of transmission lines is configured to match an input capacitance of the first differential transistor and an input capacitance of the second differential transistor. The pair of transmission lines are described in further detail above.

The method 302 may include a linearization unit providing step 310 of providing a linearization unit. The linearization unit may include one or more linearization transistors. In one embodiment, the one or more linearization transistors include a linearization gate. The linearization gate may be electrically connected to the common node. The one or more linearization transistors may also include a linearization drain electrically connected to a circuit voltage supply. The linearization unit may be configured to supply a virtual ground at the source node. In one embodiment, the linearization transistor is twice the size of the first differential transistor or the second differential transistor.

In one embodiment, the method 302 includes a source node transmission line providing step 312 of providing a source node transmission line electrically connected between the source node and a circuit ground. In one embodiment, the source node transmission line has an adjustable impedance.

The method 302 may include a first input matching transmission line providing step 314 of providing a first input matching transmission line electrically connected between the first of the two differential voltage inputs and the first differential transistor. In one embodiment, the method 302 includes a second input matching transmission line providing step 316 of providing a second input matching transmission line electrically connected between the second of the two differential voltage inputs and the second differential transistor. At least one of the first input matching transmission line and the second input matching transmission line may have an adjustable impedance.

Further details and embodiments pertaining to the linearization unit, source node transmission line, first input matching transmission line, and second input matching transmission line as well as other related circuit elements are discussed above.

While the preferred embodiments to the invention have been described, it will be understood that those skilled in the art, both now and in the future, may make various improvements and enhancements that fall within the scope of the claims which follow. These claims should be construed to maintain the proper protection for the invention first described.

What is claimed is:

1. A transconductor configured for input impedance matching and linearization, the transconductor comprising:
a first differential transistor, the first differential transistor including a first differential gate, a first differential source, and a first differential drain, the first differential gate electrically connected to a first of two differential voltage inputs;
a second differential transistor, the second differential transistor including a second differential gate, a second differential source, and a second differential drain, the second differential gate electrically connected to a second of the two differential voltage inputs, the first differential source and the second differential source electrically connected at a source node;
a pair of transmission lines, a first line of the pair of transmission lines electrically connected to the first of the two differential voltage inputs and a second line of the pair of transmission lines electrically connected to the second of the two differential voltage inputs, the pair of transmission lines electrically connecting the two differential voltage inputs at a common node; and
a linearization unit including at least one linearization transistor, the at least one linearization transistor including a linearization gate, the linearization gate electrically connected to the common node, the linearization unit configured to supply a virtual ground at the source node.

2. The transconductor of claim 1, further comprising:
a source node transmission line electrically connected between the source node and a circuit ground.

3. The transconductor of claim 2, wherein the source node transmission line has an adjustable impedance.

4. The transconductor of claim 1, wherein the at least one linearization transistor is twice the size of one of the first differential transistor and the second differential transistor.

5. The transconductor of claim 1, further comprising:
a first input matching transmission line electrically connected between the first of the two differential voltage inputs and the first differential transistor; and
a second input matching transmission line electrically connected between the second of the two differential voltage inputs and the second differential transistor.

6. The transconductor of claim 5, wherein at least one of the first input matching transmission line and the second input matching transmission line has an adjustable impedance.

7. The transconductor of claim 1, wherein the pair of transmission lines is configured to match an input capacitance of the first differential transistor and an input capacitance of the second differential transistor.

8. The transconductor of claim 1, wherein the at least one linearization transistor includes a linearization drain electrically connected to a circuit voltage supply.

9. A mixer configured for input impedance matching and linearization, the mixer comprising:
a first differential transistor, the first differential transistor including a first differential gate, a first differential source, and a first differential drain, the first differential gate electrically connected to a first of two differential voltage inputs;
a second differential transistor, the second differential transistor including a second differential gate, a second differential source, and a second differential drain, the second differential gate electrically connected to a second of the two differential voltage inputs, the first differential source and the second differential source electrically connected at a source node;
a pair of transmission lines, a first line of the pair of transmission lines electrically connected to the first of the two differential voltage inputs and a second line of the pair of transmission lines electrically connected to the second of the two differential voltage inputs, the pair of transmission lines electrically connecting the two differential voltage inputs at a common node; and
a linearization unit including at least one linearization transistor, the at least one linearization transistor including a linearization gate, the linearization gate electrically connected to the common node, the linearization unit configured to supply a virtual ground at the source node; and
a mixing unit including a mixing transistor, the mixing transistor including a mixing source, a mixing gate, and a mixing drain, the mixing gate electrically connected to a local oscillator, the mixing source electrically connected to the source node.

10. The mixer of claim 9, further comprising:
a source node transmission line electrically connected between the source node and a circuit ground.

11. The mixer of claim 10, wherein the source node transmission line has an adjustable impedance.

12. The mixer of claim 9, wherein the at least one linearization transistor is twice the size of one of the first differential transistor and the second differential transistor.

13. The mixer of claim 9, further comprising:
a first input matching transmission line electrically connected between the first of the two differential voltage inputs and the first differential transistor; and
a second input matching transmission line electrically connected between the second of the two differential voltage inputs and the second differential transistor.

14. The mixer of claim 13, wherein at least one of the first input matching transmission line and the second input matching transmission line has an adjustable impedance.

15. The mixer of claim 9, wherein the pair of transmission lines is configured to match an input capacitance of the first differential transistor and an input capacitance of the second differential transistor.

16. The mixer of claim 9, wherein the at least one linearization transistor includes a linearization drain electrically connected to a circuit voltage supply.

17. A method for input impedance matching and linearization, the method comprising:
providing a first differential transistor, the first differential transistor including a first differential gate, a first differential source, and a first differential drain, the first differential gate electrically connected to a first of two differential voltage inputs;
providing a second differential transistor, the second differential transistor including a second differential gate, a second differential source, and a second differential drain, the second differential gate electrically connected to a second of the two differential voltage inputs, the first differential source and the second differential source electrically connected at a source node;
providing a pair of transmission lines, a first line of the pair of transmission lines electrically connected to the first of the two differential voltage inputs and a second line of the pair of transmission lines electrically connected to the second of the two differential voltage inputs, the pair of transmission lines electrically connecting the two differential voltage inputs at a common node; and
providing a linearization unit including at least one linearization transistor, the at least one linearization transistor including a linearization gate, the linearization gate electrically connected to the common node, the linearization unit configured to supply a virtual ground at the source node.

18. The method of claim 17, further comprising:
providing a source node transmission line electrically connected between the source node and a circuit ground.

19. The method of claim 18, wherein the source node transmission line has an adjustable impedance.

20. The method of claim 17, wherein the at least one linearization transistor is twice the size of one of the first differential transistor and the second differential transistor.

21. The method of claim 17, further comprising:
providing a first input matching transmission line electrically connected between the first of the two differential voltage inputs and the first differential transistor; and
providing a second input matching transmission line electrically connected between the second of the two differential voltage inputs and the second differential transistor.

22. The method of claim 21, wherein at least one of the first input matching transmission line and the second input matching transmission line has an adjustable impedance.

23. The method of claim 17, wherein the pair of transmission lines is configured to match an input capacitance of the first differential transistor and an input capacitance of the second differential transistor.

24. The method of claim 17, wherein the at least one linearization transistor includes a linearization drain electrically connected to a circuit voltage supply.
